(19) United States
(12) Patent Application Publication
(10) Pub. No.: US 2011/0035713 A1
(43) Pub. Date: Feb. 10, 2011

(54) CIRCUIT BOARD DESIGN SYSTEM AND METHOD

(75) Inventors: YUNG-CHIEH CHEN, Tu-Cheng (TW); HSIEN-CHUAN LIANG, Tu-Cheng (TW); SHEN-CHUN LI, Tu-Cheng (TW); SHOU-KUO HSU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/650,758

(22) Filed: Dec. 31, 2009

(30) Foreign Application Priority Data
Aug. 7, 2009 (CN) 200910305354.6

(51) Int. Cl. G06F 17/50

(52) U.S. Cl. 716/106; 716/126; 716/130

(57) ABSTRACT

A method and system for designing a circuit board designs wiring of the circuit board, and determines electronic rules and physical rules of the wiring design. The method and system creates a board file by designating a file name, outputs the electronic rules into the board file, and outputs the physical rules into the board file according to a preset output format. The method and system further generates a circuit diagram according to preset initial parameters, and applies the electronic rules and the physical rules to the circuit diagram according to the board file.

### BACKGROUND

1. Technical Field

Embodiments of the present disclosure generally relate to systems and methods for designing electronic devices, and more particularly to circuit board design system and method for an electronic device.

2. Description of Related Art

Design of an electronic device (e.g., a computer, or a server) usually include wiring design for a circuit board of the electronic device, and simulating and analyzing the wiring design, to determine attributes of the wiring design. The attributes of the wiring design include electronic rules (e.g., a max via count on the circuit board) and physical rules (e.g., a net physical type, and a net spacing type). A circuit diagram of the circuit board is designed according to the wiring design and attributes.

Design Entry HDL is a software platform for design of circuit boards of electronic devices provided by CADENCE. However, using the Design Entry HDL, the circuit diagram cannot be automatically adjusted according to the physical rules, but needs to be adjusted by layout engineers manually.

### BRIEF DESCRIPTION OF THE DRAWINGS

FIG. 1 is a block diagram of one embodiment of a system for designing a circuit board.

FIG. 2 is a block diagram illustrating function modules of the system of FIG. 1.

FIG. 3 is an example of an output format of physical rules of the circuit board.

FIG. 4 is a flowchart of one embodiment of a method for designing a circuit board.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

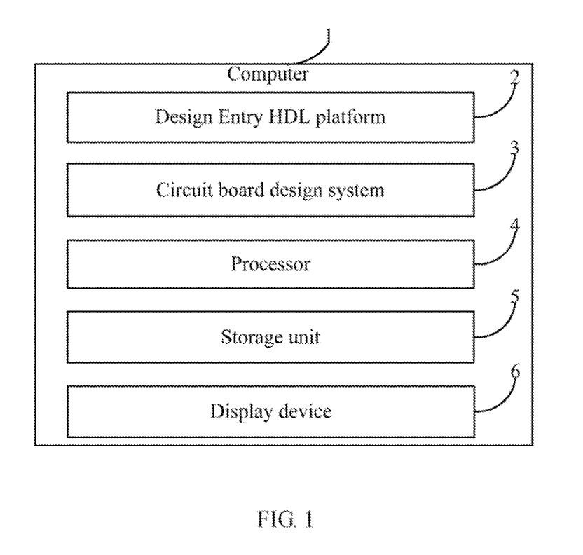

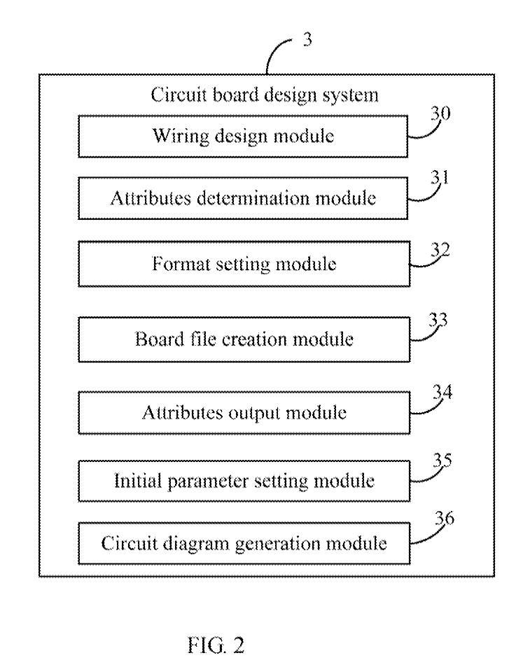

FIG. 1 is a block diagram of one embodiment of a circuit board design system 3. In present embodiment, the circuit board design system 3 may be included in a computer 1 which further includes a Design entry HDL platform 2, a processor 4, and a storage unit 5. The system 3 includes a plurality of function modules (see below descriptions referring to FIG. 2), operable to design wiring of the circuit board and automatically apply attributes, including electronic rules and physical rules of the wiring design to a circuit diagram of the circuit board on the Design entry HDL platform 2. The processor 4 of the computer 1 executes one or more computerized codes of the function modules of the system 3, and the storage unit 5 of the computer 1 stores the one or more computerized codes of the functional modules of the system 3.

FIG. 2 is a block diagram illustrating the function modules of the system 3. In the present embodiment, the function modules of the system 3 may include a wiring design module 30, an attributes determination module 31, a format setting module 32, a board file creation module 33, an attributes output module 34, an initial parameter setting module 35, and a circuit diagram generation module 36.

The wiring design module 30 is operable to receive a wiring design of the circuit board. The wiring design may be in electronic form and may be designed in any number of well-known circuit board design programs, such as Design Entry HDL.

The attributes determination module 31 is operable to determine electronic rules and physical rules of the wiring design by simulating and analyzing the wiring design. The electronic rules may include max via count, stub length, max/min/relative trace length, and phase tolerance, for example. The physical rules may include a net physical type and a net spacing type. The net physical type may include trace width and routing layer, for example. The net spacing type may include intra-pair spacing, inter-pair spacing, spacing to others, and router layer, for example.

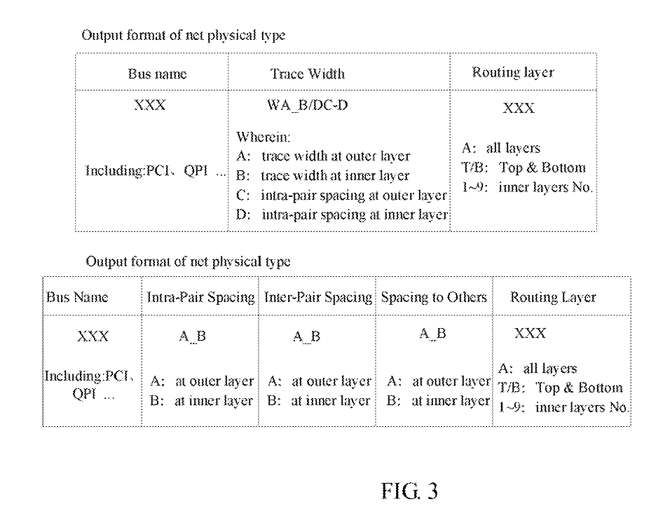

The format setting module 32 is operable to receive a preset output format of the physical rules. One example of an output format is shown in FIG. 3.

The board file creation module 33 is operable to create a board file by designating a file name (e.g., “123.brd”).

The attributes output module 34 is operable to output the electronic rules into the board file, and further output the physical rules into the board file according to the preset output format.

The initial parameter setting module 35 is operable to set initial parameters of generating a circuit diagram of the circuit board. In the present embodiment, the initial parameters may include stepped construction of the circuit board and a number of power supplies on the circuit board, for example.

The circuit diagram generation module 36 is operable to generate the circuit diagram according to the initial parameters, apply the electronic rules and the physical rules to the circuit diagram according to the board file, and display the circuit diagram on a display device 6 of the computer 1.

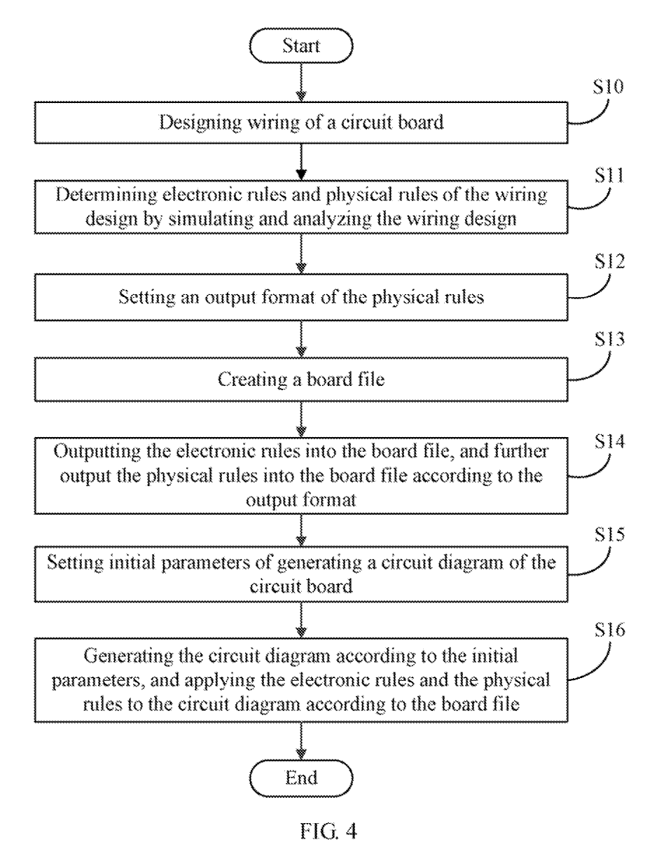

FIG. 4 is a flowchart of one embodiment of a method for designing a circuit board. In one embodiment, the method runs on the Design entry HDL platform 2. Depending on the embodiment, additional blocks in the flow of FIG. 4 may be added, others removed, and the ordering of the blocks may be changed.

In block S10, the wiring design module 30 receives a wiring design of the circuit board.

In block S11, the attributes determination module 31 determines electronic rules and physical rules of the wiring design by simulating and analyzing the wiring design. As mentioned above, the electronic rules may include max via count, stub length, max/min/relative trace length, and phase tolerance, for example. The physical rules may include a net physical type and a net spacing type. The net physical type may include trace width and routing layer, for example. The net spacing type may include intra-pair spacing, inter-pair spacing, spacing to others, and router layer, for example.

In block S12, the format setting module 32 receives a preset output format of the physical rules, as shown in FIG. 3.

In block S13, the board file creation module 33 creates a board file by designating a file name (e.g., “123.brd”).

In block S14, the attributes output module 34 outputs the electronic rules into the board file, and further outputs the physical rules into the board file according to the output format.

In block S15 the initial parameter setting module 35 sets initial parameters of generating a circuit diagram of the circuit board. In present embodiment, the initial parameters may include stepped construction of the circuit board, and a number of power supplies on the circuit board, for example.

In block S16, the circuit diagram generation module 36 generates the circuit diagram according to the initial parameters, applies the electronic rules and the physical rules to the circuit diagram according to the board file, and displays the circuit diagram on the display device 6 of the computer 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for designing a circuit board, the method being performed by execution of computer readable program code by at least one processor of at least one computer system, the method comprising:
designing wiring of the circuit board;
determining electronic rules and physical rules of the wiring design by simulating and analyzing the wiring design;
presetting an output format of the physical rules;
creating a board file by designating a file name;
outputting the electronic rules into the board file, and outputting the physical rules into the board file according to the output format;
setting initial parameters of generating a circuit diagram of the circuit board; and
generating the circuit diagram according to the initial parameters, applying the electronic rules and the physical rules to the circuit diagram according to the board file, and displaying the circuit diagram on a display device.

2. The method as described in claim 1, wherein the method runs on a Design entry HDL platform.

3. The method as described in claim 1, wherein the initial parameters comprise stepped construction of the circuit board, and a number of power supplies on the circuit board.

4. A storage medium having stored thereon instructions that, when executed by a processor, cause the processor to perform a method for designing a circuit board, wherein the method comprises:
designing wiring of the circuit board;
determining electronic rules and physical rules of the wiring design by simulating and analyzing the wiring design;
presetting an output format of the physical rules;
creating a board file by designating a file name;
outputting the electronic rules into the board file, and outputting the physical rules into the board file according to the output format;
setting initial parameters of generating a circuit diagram of the circuit board; and
generating the circuit diagram according to the initial parameters, applying the electronic rules and the physical rules to the circuit diagram according to the board file, and displaying the circuit diagram.

5. The storage medium as described in claim 4, wherein the method runs on a Design entry HDL platform.

6. The storage medium as described in claim 4, wherein the initial parameters comprise stepped construction of the circuit board, and a number of power supplies on the circuit board.

7. A system for designing a circuit board, the system comprising:
a wiring design module operable to receive a wiring design of the circuit board;
an attributes determination module operable to determine electronic rules and physical rules of the wiring design by simulating and analyzing the wiring design;
a format setting module operable to receive a preset output format of the physical rules;
a board file creation module operable to create a board file by designating a file name;
an attributes output module operable to output the electronic rules into the board file, and further output the physical rules into the board file according to the output format;
an initial parameter setting module operable to set initial parameters of generating a circuit diagram of the circuit board;
a circuit diagram generation module operable to generate the circuit diagram according to the initial parameters, apply the electronic rules and the physical rules to the circuit diagram according to the board file, and display the circuit diagram on a display device; and
a processor that executes the wiring design module, the attributes determination module, the format setting module, the board file creation module, the attributes output module, the initial parameter setting module, and the circuit diagram generation module.

8. The system as described in claim 7, wherein the system is executed on a Design entry HDL platform.

9. The system as described in claim 7, wherein the initial parameters comprise stepped construction of the circuit board, and a number of power supplies on the circuit board.
